(19) United States
(12) Patent Application Publication
(10) Pub. No.: US 2014/0120885 A1
(43) Pub. Date: May 1, 2014

(54) SYSTEM AND METHOD FOR HANDLING UNDESIRED PHONE CALLS

(71) Applicant: David J. Luneau, Hopkinton, NH (US)

(72) Inventor: David J. Luneau, Hopkinton, NH (US)

(21) Appl. No.: 13/665,025

(22) Filed: Oct. 31, 2012

(51) Int. Cl. H04W 4/00; H04M 3/42

(52) U.S. Cl. 455/414.1; 379/201.02

(57) ABSTRACT

In a system and method in which an incoming communication is received at a called station from a source, indicia identifying the source can be determined, and compared to stored indicia. Content can be exchanged between the called station and the source, and a record created that includes both the indicia and at least a portion of at least one of the incoming communication or the content. Records from a plurality of called stations can be analyzed by a server to identify instances in which a called station has received incoming communications from the source. The system and method can for example be used to help reduce or eliminate the harassment of unwanted calls, and/or to assist in determining and establishing whether a called party has been injured by repeated communication from an undesired party, and/or to assist with seeking financial relief for the injured party.

### FIELD OF THE INVENTION

The present invention generally relates to a system and method for handling undesired telephone calls and text messages.

### BACKGROUND

In recent years, there has been an ever-increasing volume of telephone calls and text messages sent to mobile stations (MS) also commonly known as cell phones. In fact, many people now rely on their MS as their primary, if not exclusive, means for telecommunication.

Recent years have also seen a growth in the number of undesired communication from organizations such as telemarketing companies. In the past, such calls were primarily directed to land line numbers. Families were frequently interrupted during dinner or at other inconvenient times to answer an undesired call. As one solution, consumers purchased products like the VoiceAnnounce® Caller ID Model 9500, manufactured by ClassCo Inc., which announced the identity of the calling party, without the consumer having to run to the telephone. It also allowed a consumer to program the unit to answer calls from specific telephone numbers and play a pre-recorded audible outgoing message to the caller.

To address concerns surrounding unwanted solicitation phone calls, the United States Congress passed a bill called the Telephone Consumer Protection Act of 1991 (TCPA), which was signed into law by President George H. W. Bush. The TCPA restricts telephone solicitations and limits the use of automated telephone calling equipment such as automated dialers and equipment for delivering pre-recorded voice messages and text messages. The TCPA also established a National Do Not Call Registry, and requires solicitors to maintain their own “Do Not Call” list and to transmit their telephone number as part of the caller ID information. A party on the Do Not Call list is entitled to monetary damages for each call received in violation of the TCPA.

Using the caller ID feature, some MS devices automatically suppress the audible ring, and/ or immediately transfer to voicemail, when calls from specific telephone numbers are received. While these features may reduce the immediate annoyance and disruption of such calls, it does not necessarily put a stop to the undesired communication, or even discourage unwanted callers from placing unwanted calls. Moreover, unlike land lines, the cost of the unwanted incoming call may be the responsibility of the called party.

### SUMMARY OF THE INVENTION

One aspect of the present invention concerns a method in which an incoming communication is received from a source at a called station. Indicia identifying the source are determined, and compared to stored indicia. On the basis of the results of the comparison, content is exchanged between the called station and the source and a record created that includes both the indicia and at least a portion of at least one of the incoming communication or the content.

In embodiments of this aspect, the incoming communication is one or more of a phone call (such as an unwanted phone call), SMS, or email, from a source such as a telemarketer. The called station can be either a mobile handset or a landline, and the indicia identifying the source is, for example, caller-identification information, a name, or an email address. The content can be a prerecorded outgoing message, for example that instructs the source to stop calling. Moreover, creating the record can include recording and/or storing the record, which can includes time indicia such as the date and time when the incoming communication was received.

Embodiments of the method can also include sending the record to a remote location, such as a server that includes a database with plural stored records. The server can process the record received from the called station to determine if the called station has previously received incoming communications from the source. The server can additionally or alternatively determine if the record is related to any of the stored records, such as by determining whether the indicia of the record is the same as the indicia of any of the stored records, determining whether a name associated with the record is the same as a name associated with any of the stored records, and/or determining whether any of the content in the record is the same as any of the content in any of the stored records. The method can also involve determining the number of times that the called station has previously received incoming communications from the source, and compiling a set of records for all times that the called station has previously received incoming communications from the source.

Another aspect of the present invention concerns a method in which records are received from a plurality of called stations, where each record comprises indicia identifying a source of an incoming communication to the called station and at least a portion of at least one of the incoming communication or other content exchanged between the called station and the source. Records are stored in a database, which is queried to identify instances in which a called station has received incoming communications from the source.

Embodiments of the method can also include identifying instances in which a called station has received incoming communications from the source includes determining whether the indicia of the received record is the same as the indicia of any of the stored records, such as by determining whether a name associated with the received record is the same as a name associated with any of the stored records, determining whether any of the content in the record is the same as any of the content in any of the stored records, and/or employing information retrieval techniques.

Another aspect of the present invention concerns a mobile handset with an antenna, transceiver circuitry operatively connected to the antenna for providing received data representing received signals and for transmitting send data, a processor, and memory storage operatively connected to the processor. The processor is configured to analyze received data to identify indicia representative of a sender of the received data, store in memory indicia representative of one or more senders, and retrieve from memory indicia representative of one or more senders. For a given set of received data, the processor can compare indicia identifying a source of at least part of that set of received data with indicia representative of one or more senders retrieved from memory, and on the basis of the results of the comparison, prepare send data and store in memory a record that includes both the indicia for the given set of received data and at least a portion of at least one of the given set of received data or the send data.

In embodiments of this aspect the incoming communication is one or more of a phone call, SMS, or email, and the indicia identifying the source is caller-identification information, a telephone number and/or an email address. The send data can be a prerecorded outgoing message, such as one that instructs the source to stop calling. The record can includes time indicia. The processor can also cause the transceiver to send the record to a remote location.

Embodiments of the present invention concern systems and methods for identifying undesired telephone calls (such as from a number that is not in service). Such embodiments not only play an audible outgoing message to incoming calls from specific telephone numbers, but also keep detailed records of each transaction (which can include both the incoming call and the outgoing message, or portions thereof), and if the undesired calls do not stop, pursuing all lawful steps against the offending party to provide relief to the injured party, including if the undesired party continues to attempt communication. Moreover, in embodiments of the invention, the audible alert (e.g., the ringer) can be automatically suppressed when communication is received from an undesired party, and/or the call automatically can be terminated. Additionally or alternatively, the call can be automatically routed to a voice messaging system and/or a voicemail system.

Embodiments of the invention thus not only can reduce or eliminate the harassment of unwanted calls, but can assist in determining and establishing whether a called party has been injured by repeated communication from an undesired party, and assist with seeking financial relief for the injured party.

### BRIEF DESCRIPTION OF DRAWINGS

FIG. 1 is a block schematic diagram of the system in accordance with one embodiment of the invention.

FIG. 2 is a flow chart illustrating the method followed for incoming telephone calls in accordance with one embodiment of the invention.

FIG. 3 is a flow chart illustrating the method followed for incoming text messages in accordance with one embodiment of the invention.

FIG. 4 is a flow chart illustrating the method followed by the network application server when receiving event data in accordance with one embodiment of the invention.

FIG. 5 is a flow chart illustrating the method followed by the network application server when receiving account access requests in accordance with one embodiment of the invention.

### DETAILED DESCRIPTION

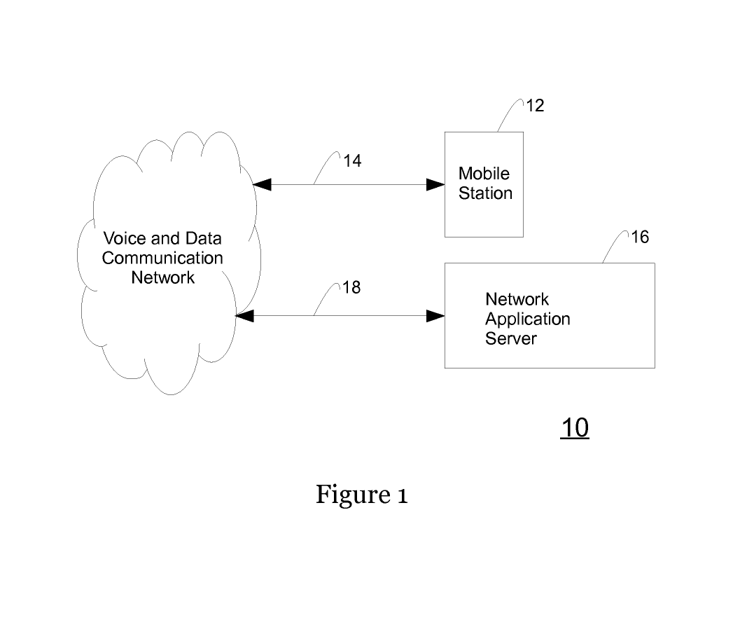

FIG. 1 is a diagram of system 10, which includes a mobile station 12, interface 14 for providing an operative connection between station 12 and a voice and data communication network, a network application server 16, and interface 18 for providing an operative connection between server 16 and a voice and data communication network. Mobile station 12 is a typical “smart” cellular phone, such as the Motorola Razr Maxx, but the system can also work with landline stations and/or other types of mobile stations, including stations that employ voice over Internet protocol (VoIP) technology. Server 16 is typically an Intel-based computing platform designed for network-based applications running a server operating system, such as Windows Server or Linux.

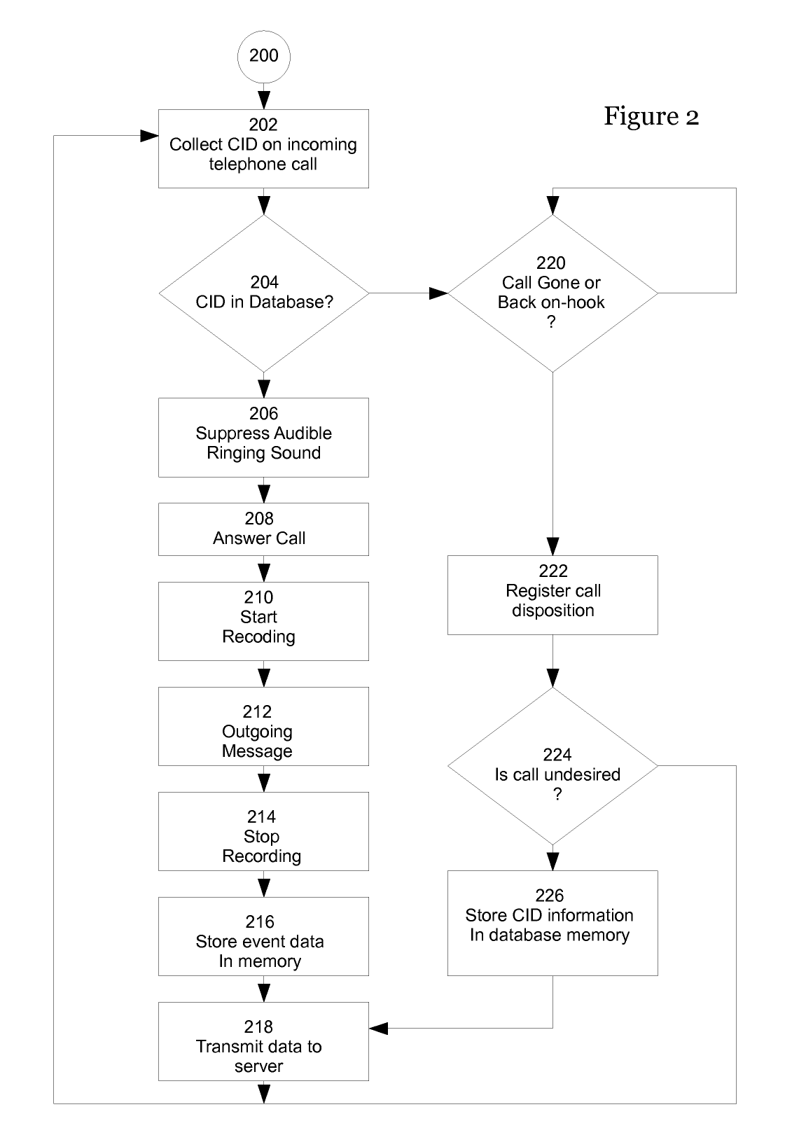

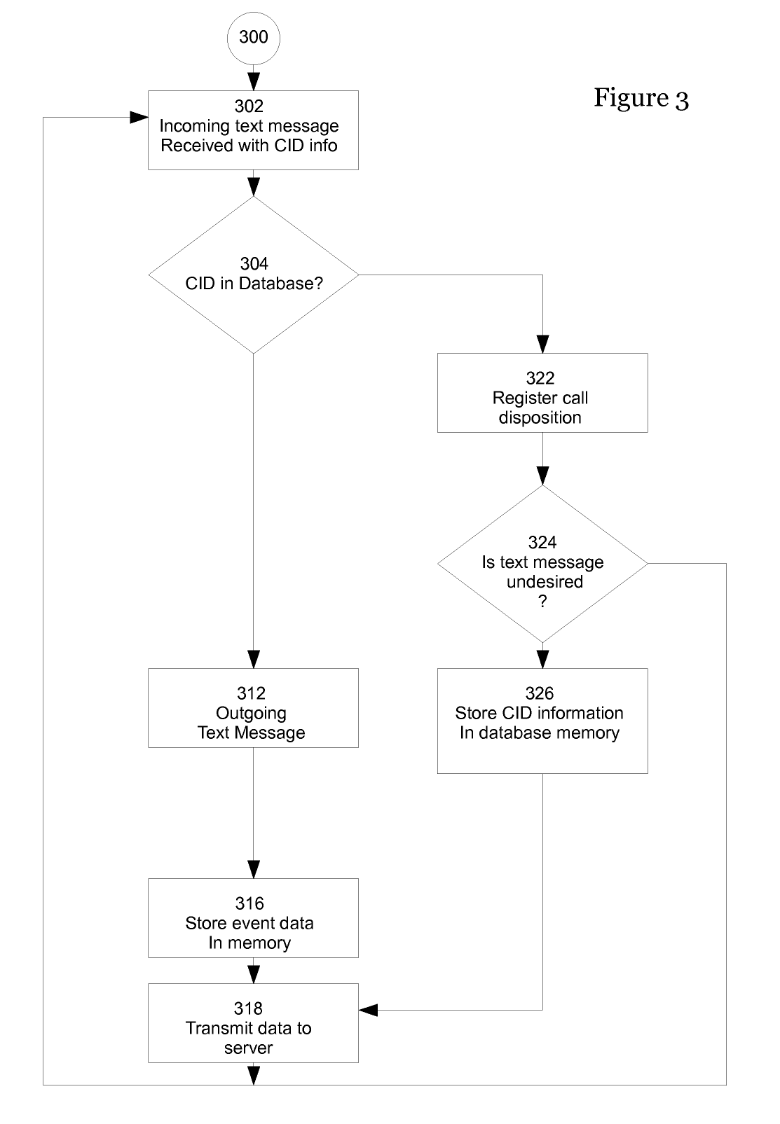

Station 12 can receive telephone calls and text messages via interface 14. Station 12 has the functionality to answer telephone calls, receive audio from a calling party, transmit audio to a calling party, terminate a telephone call, display text messages and transmit text messages. Station 12 also has the functionality to transmit and receive data via interface 14 to and from server 16. Station 12 has a processor and memory that can perform the steps outlined in FIGS. 2 and 3.

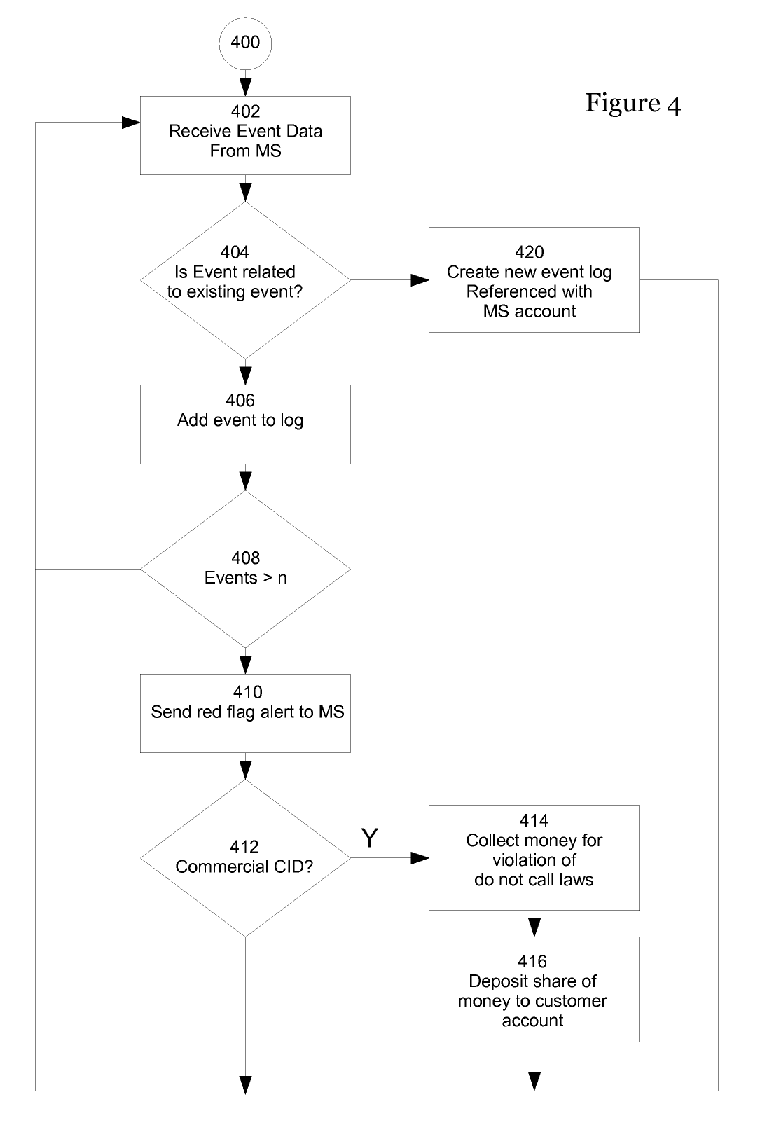

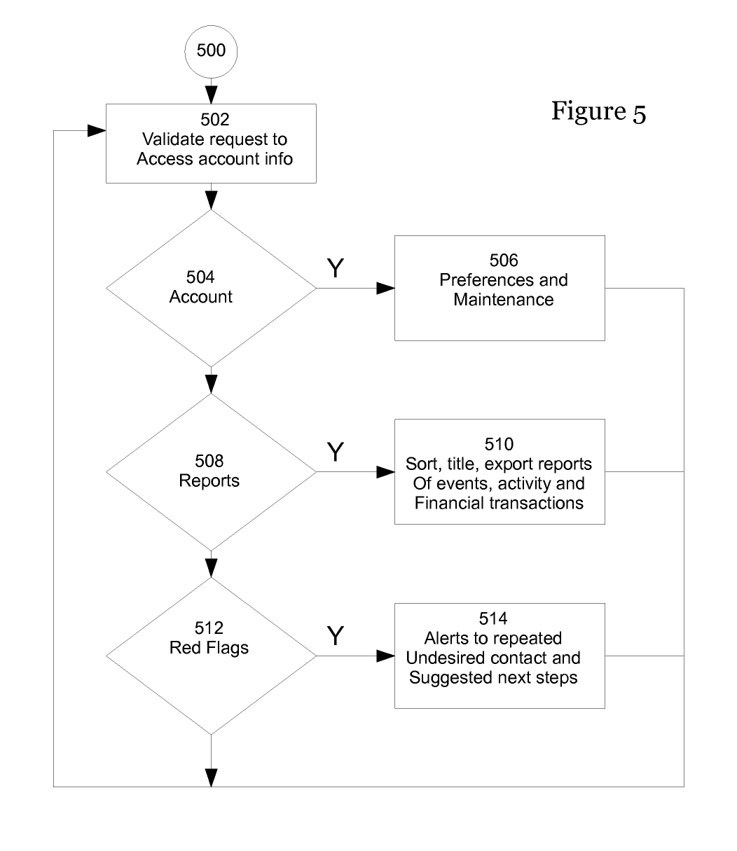

Server 16 can transmit and receive data via interface 18 to and from station 12. For example, server 16 can transmit and receive data from resources such as email or the web, or peripherals such as a display screen and a keyboard. Server 16 has a processor and memory that can perform the steps outlined in FIGS. 4 and 5.

FIG. 2 is a flow chart illustrating the method followed when station 12 receives an incoming telephone call. Upon receiving an incoming telephone call, process 202 collects the caller identification (CID) information associated with the incoming call. Process 204 searches through a database of undesired telephone numbers stored in the memory of station 12 for a match to the CID information received with the present telephone call.

In the case of a match, process 206 stops the audible alert (ringer) from sounding, as this call will not require the attention of the user of station 12. Rather, process 208 answers the incoming call, followed by process 210, which begins recording the two-way audio communication between the calling party and station 12, which includes both audio from the calling party and an outgoing audio message transmitted by station 12 to the calling party by process 212. In the case where the audio from the calling party and the outgoing audio message are available as separate audio signals, the recording may employ multiple tracks. This outgoing audio message is stored in the memory of station 12 and for example states:

“This call is being recorded. This message serves as formal notice to cease and desist calling this telephone number, and if your call is from a marketing organization, to immediately place this telephone number on your do not call list.”

Upon completion of the outgoing audio message, process 214 stops the recording and terminates the call, returning station 12 to the on-hook state. Process 216 stores the event data (calling party number, calling party name if available, date/time of call, and audio recording) in the memory of station 12. Finally, process 218 transmits this event data to server 16 and returns to process 200 to wait for another incoming telephone call.

In the case where process 204 does not find a match between the number of the incoming call and the list of undesired telephone numbers in the database, process 220 waits until station 12 returns to the on-hook state (assuming the called party answers the call by placing station 12 in the off-hook state), or until the incoming call appearance is gone (for example, the calling party hangs up.) Process 222 registers input from the user interface of station 12 and process 224 determines whether that input reflects the designation of the incoming call as being from an undesired telephone number. If so, process 226 stores the caller identification (CID) information for the most-recent incoming call into the database of undesired telephone numbers in the memory of station 12, and jumps to process 218. If the calling party's telephone number is not undesirable, processing returns to process 200 to wait for the next incoming call.

FIG. 3 is a flow chart illustrating the method followed when station 12 receives an incoming text message. Upon receiving an incoming text message, process 302 collects the CID information associated with the incoming text message. Process 304 searches through the database of undesired telephone numbers stored in the memory of station 12 for a match to the CID information received with the present text message.

In the case of a match, process 312 transmits a pre-defined text message back to the sender of the received text message. This outgoing text message is stored in the memory of station 12, and states:

“This message servers as formal notice to cease and desist contacting this telephone number, and if your communication is from a marketing organization, to place this telephone number on your do not contact list.”

Upon completion of the outgoing text message, process 316 stores the event data (calling party number, calling party name if available, date/time of text message, and the content of the text messages) in the memory of station 12. Finally process 318 transmits this event data to server 16 and returns to process 300 to wait for another incoming text message.

In the case process 304 does not find a match in the database of undesired telephone numbers, process 322 registers input from the user interface of station 12 and process 324 determines whether that input reflects the determination that the incoming text message was from an undesired telephone number. If so, process 326 stores the text message's CID information into the database of undesired telephone numbers in the memory of station 12, and jumps to process 318. Otherwise, processing returns to process 300 to wait for the next incoming text message.

FIG. 4 is a flow chart illustrating the method followed by the network application server when receiving event data. Server 16 begins this method at process 402 when it receives event data from a station 12. When the event is a result of a received text message, the event data includes the calling party number, calling party name if available, date/time of text message, and the content of the text messages. When the event is a result of a received telephone call, the event data includes the calling party number, calling party name if available, date/time of call, and the audio recording of the call. Along with the event data, server 16 receives the identity of station 12. Together, the event data and the identity of station 12 comprise the event.

At process 404, the received event is analyzed to determine whether it is related to one or more events stored in the memory of server 16. Server 16 may employ several techniques to determine whether the received event is related to a stored event, such as inspecting the calling party number in the received event data for a known association with calling party numbers contained in stored events, and/or inspecting the recorded audio message or text message for content that is the same as or similar to stored events. For example, information retrieval and data analysis techniques such as pattern-matching (e.g., looking for data in the format of telephone numbers), keyword searching (e.g., looking for words such as “offer,” “deal,” “investment,” “stock,” “money,” “vacation,” “free” and/or the like), word count, and/or word frequency can be used to inspect for content. The data can also be analyzed for “false positive” keywords or other information that would signify that the event was erroneously flagged as coming from an undesirable caller (e.g., “mom,” “dinner,” or “Thanksgiving”). Server 16 may send certain information, such as telephone numbers related to the one from the received event, to station 12 in effort to help station 12 identify future undesired telephone calls and text messages. If the event is not related to a stored event, process 420 creates a new event log for this event and stores it in the memory of server 16.

From process 404, when the received event is related to a stored event, process 406 stores the received event in the event log in the memory of server 16 for that stored event. Process 408 next determines whether the number of related events received from the station 12 exceeds a pre-determined threshold. If the threshold is not exceeded, processing returns back to the top to wait for the next transmission from a station 12.

Exceeding this pre-determined threshold means that the station 12 has received repeated undesired contact from the same organization or individual. When process 408 determines the threshold has been exceeded, process 410 sends a “red flag” alert to the station 12, indicating that a repeated undesired contact has been detected.

Next, process 412 is followed to determine if the event is of a commercial nature, such as contact from a marketing company. Server 16 may employ several techniques to qualify the nature of the call, such as inspecting the calling party number received in the event data for a known association with a commercial organization, and/or inspecting the recorded audio message or text message for commercial content, such as in the manners described above. If the event is not commercial in nature, the process returns to the top to wait for the next data transmission from a station 12.

If the event is commercial in nature and if the call was placed in violation of “do not call” and “do not contact” laws, process 414 collects compensatory civil damages. Many governments at all levels have set standards for compensatory damages that can be collected in civil court proceedings. Factors considered when determining damages include the number of calls made in violation of “do not call” laws, the ways in which the violations were committed, such as passing false telephone numbers in the caller identification information, and the real damages incurred by the called party.

Process 414 may invoke as many steps as necessary, including determining whether pre-recorded outgoing messages were used by the calling party, and/or whether the calling party telephone number transmitted in the caller identification information was faked (which can be evaluated by placing a call to that number and detecting a network special information (SIT) tone). Process 414 may also include steps in support of collecting monetary relief from the unlawful party, including invoicing, bill collection, settlement negotiation and court proceedings.

In the event of a monetary recovery, process 416 sends station 12 an alert to advise of that fact. The money can be transferred to the user of station 12 according to their account preferences, such as deposited to a personal bank account or issued on a gift card. The related events are marked closed, and the process returns back to the top.

FIG. 5 is a flow chart illustrating the method followed by the network application server when receiving account access requests. This method begins at process 502, when a request for account access has been received. This request for account access may come from an application running on station 12 or from a web browser. Process 502 performs an authorization routine to validate the access request, and when validated, presents a menu of options for managing the account, accessing reports, and reviewing “red flag” alerts.

Process 504 determines if there is a request to manage the account, and if so proceeds to process 506. Process 506 presents options to change or update information associated with the account, such as access restrictions, authorization credentials, and other preferences. When complete, processing returns to the top to wait for another access request.

Process 508 determines if there is a request to access reports, and if so proceeds to process 510. Process 510 presents options to sort through, review, title, export, and delete specific events and event logs, and review financial transactions. When complete, processing returns to the top to wait for another access request.

Process 512 determines if there is a request to access active “red flag” alerts, and if so proceeds to process 514. Process 514 reviews active “red flag” alerts, such as repeated undesired contact from an organization or individual, what actions are being taken, such as collection of compensatory damages as a result of a violation of do-not-call statutes, and what actions could be taken in the case of non-commercial repeated undesired contact, such as providing a referral to third party professional service providers, for instance a law firm or private investigator. When complete, processing returns to the top to wait for another access request.

Other embodiments are within the scope of the following claims.

1. A method comprising:
receiving an incoming communication from a source at a called station;
determining indicia identifying the source;
comparing the indicia identifying the source to stored indicia;
on the basis of the results of the comparison:
(i) exchanging content between the called station and the source and
(ii) creating a record that includes both the indicia and at least a portion of at least one of the incoming communication or the content.

2. The method of claim 1 wherein the incoming communication is one or more of a phone call, SMS, or email.

3. The method of claim 2 wherein the incoming communication is an unwanted phone call.

4. The method of claim 1 wherein the source is a telemarketer.

5. The method of claim 1 wherein the called station is a mobile telephone station.

6. The method of claim 1 wherein the called station is a fixed-line telephone station.

7. The method of claim 1 wherein the called station employs stations employs voice over Internet protocol (VoIP) technology.

8. The method of claim 1 wherein the indicia identifying the source is caller-identification information.

9. The method of claim 1 wherein the indicia identifying the source is a name.

10. The method of claim 1 wherein the indicia identifying the source is an email address.

11. The method of claim 1 wherein the content is a prerecorded outgoing message.

12. The method of claim 11 wherein the prerecorded outgoing message instructs the source to stop calling.

13. The method of claim 1 wherein creating a record includes recording the record.

14. The method of claim 1 wherein creating a record includes storing the record.

15. The method of claim 1 wherein the record further includes time indicia.

16. The method of claim 15 wherein the time indicia includes the date and time when the incoming communication was received.

17. The method of claim 1 further comprising sending the record to a remote location.

18. The method of claim 17 wherein the remote location is a server.

19. The method of claim 17 wherein the remote location includes a database.

20. The method of claim 19 wherein the database includes plural stored records.

21. The method of claim 20 further comprising processing the record received from the called station to determine if the called station has previously received incoming communications from the source.

22. The method of claim 21 further comprising determining if the record is related to any of the stored records.

23. The method of claim 22 wherein determining if the record is related to any of the stored records includes determining whether one or more of the indicia of the record is the same as one or more of the indicia of any of the stored records.

24. The method of claim 22 wherein determining if the record is related to any of the stored records includes determining whether a name associated with the record is the same as a name associated with any of the stored records.

25. The method of claim 22 wherein determining if the record is related to any of the stored records includes determining whether any of the content in the record is the same as any of the content in any of the stored records.

26. The method of claim 1 further comprising determining the number of times that the called station has previously received incoming communications from the source.

27. The method of claim 26 further comprising compiling a set of records for all times that the called station has previously received incoming communications from the source.

28. A method comprising:
receiving records from a plurality of called stations, wherein each record comprises:
(i) indicia identifying a source of an incoming communication to the called station; and
(ii) at least a portion of at least one of the incoming communication or other content exchanged between the called station and the source;
storing records in a database;
querying the database to identify instances in which a called station has received incoming communications from the source.

29. The method of claim 28 wherein identifying instances in which a called station has received incoming communications from the source includes determining whether one or more of the indicia of the received record is the same as one or more of the indicia of any of the stored records.

30. The method of claim 28 wherein identifying instances in which a called station has received incoming communications from the source includes determining whether a name associated with the received record is the same as a name associated with any of the stored records.

31. The method of claim 28 wherein identifying instances in which a called station has received incoming communications from the source includes determining whether any of the content in the record is the same as any of the content in any of the stored records.

32. The method of claim 28 wherein identifying instances in which a called station has received incoming communications from the source includes employing information retrieval techniques.

33. A mobile telephone station comprising:
an antenna;
transceiver circuitry operatively connected to the antenna for providing received data representing received signals and for transmitting send data;
a processor;
memory storage operatively connected to the processor;
wherein the processor is configured to:
analyze received data to identify indicia representative of a sender of the received data;
store in memory indicia representative of one or more senders;
retrieve from memory indicia representative of one or more senders;
for a given set of received data, compare indicia identifying a source of at least part of that set of received data with indicia representative of one or more senders retrieved from memory, and on the basis of the results of the comparison, prepare send data and store in memory a record that includes both the indicia for the given set of received data and at least a portion of at least one of the given set of received data or the send data.

34. The mobile telephone station of claim 33 wherein the incoming communication is one or more of a phone call, SMS, or email.

35. The mobile telephone station of claim 33 wherein the indicia identifying the source is caller-identification information.

36. The mobile telephone station of claim 33 wherein the indicia identifying the source is a telephone number.

37. The mobile telephone station of claim 33 wherein the indicia identifying the source is an email address.

38. The mobile telephone station of claim 33 wherein the send data is a prerecorded outgoing message.

39. The mobile telephone station of claim 38 wherein the prerecorded outgoing message instructs the source to stop calling.

40. The mobile telephone station of claim 33 wherein the record further includes time indicia.

41. The mobile telephone station of claim 33 wherein the processor is further configured to cause the transceiver to send the record to a remote location.
